(19) United States
(12) Patent Application Publication
(10) Pub. No.: US 2017/0194622 A1
(43) Pub. Date: Jul. 6, 2017

(54) ENERGY STORAGE DEVICE HAVING SEPARATOR AND MUD REST FLUID FLOW PATH FEATURES

(71) Applicant: Ingersoll-Rand Company, Davidson, NC (US)

(72) Inventor: Paul W. McLeod, Grovetown, GA (US)

(21) Appl. No.: 15/392,183

(22) Filed: Dec. 28, 2016

Related U.S. Application Data
(60) Provisional application No. 62/273,585, filed on Dec. 31, 2015.

(51) Int. Cl. H01M 2/40; H01M 2/12; H01M 2/18; H01M 2/02

(52) U.S. Cl. CPC H01M 2/40; H01M 2/025; H01M 2/12; H01M 2/18

(57) ABSTRACT

An energy storage device is disclosed that in one embodiment is a rechargeable battery. The device includes a container within which is disposed battery plates, separators, and battery fluid. A mud well having mud rests is also disposed within the container. The separator can be formed as a pocket for insertion of a battery plate. The separator can include channel features sized to convey a gaseous byproduct of a charging event of the battery. In one form the mud rests define passages, such as an internally formed passage, that assist in the circulation of battery fluid.

### TECHNICAL FIELD

The present invention generally relates to rechargeable batteries, and more particularly, but not exclusively, to flooded batteries having mud rests with internal passages.

### BACKGROUND

Providing energy storage devices, such as in rechargeable batteries having an internal battery fluid, with flow path features remains an area of interest. Some existing systems have various shortcomings relative to certain applications. Accordingly, there remains a need for further contributions in this area of technology.

### SUMMARY

One embodiment of the present invention is a unique energy storage device. Other embodiments include apparatuses, systems, devices, hardware, methods, and combinations for improved battery fluid flow in an energy storage device. Further embodiments, forms, features, aspects, benefits, and advantages of the present application shall become apparent from the description and figures provided herewith.

### BRIEF DESCRIPTION OF THE FIGURES

FIG. 1 depicts an embodiment of an energy storage device.

FIG. 2 depicts another embodiment of an energy storage device.

FIG. 3 depicts another embodiment of an energy storage device.

FIG. 4 depicts a view of the energy storage device including mud rests and partitions.

FIG. 5 is a cross sectional view of FIG. 4.

FIG. 6 depicts embodiments of the battery plates.

FIG. 7 depicts a side view of FIG. 5.

FIG. 8 depicts an embodiment of a separator material and an embodiment of a pocket separator.

FIG. 9 depicts an embodiment of a separator material stock.

FIG. 10 depicts an embodiment of a separator material stock.

FIG. 11 depicts a cross sectional view of separator material stock that includes channel features.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

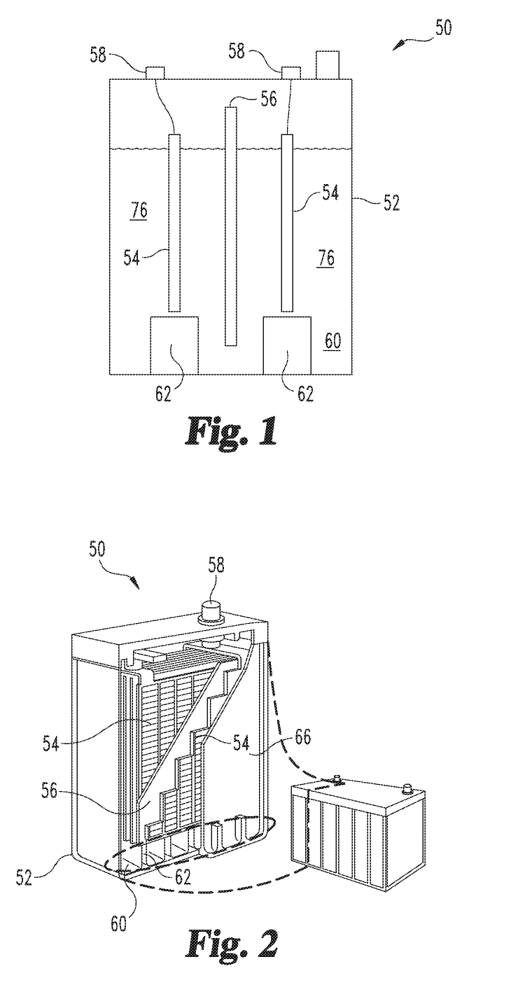

Shown in FIG. 1 is a schematic of an energy storage device 50 in the form of a battery. The battery includes a container 52, a plurality of battery plates 54 disposed within the container 52, and a separator 56 used between the battery plates 54. A battery fluid, such as an electrolyte, is typically included in the battery to complete the electrolytic cell. In one form the battery is a lead acid battery, but other energy storage device forms are contemplated which include plates and an electrolytic fluid. Although the illustrated embodiment depicts just two schematic plates 54, any number of plates 54 are used in various embodiments contemplated herein. The plates 54 used within the energy storage device 50 are generally separated into two sets of opposite polarity plates which can be connected respectively to externally accessible terminals 58 (also of opposite polarity). The polarity of each set of plates 54 can be determined as a result of whether the energy storage device is charging or discharging: during a discharge event the plates can be deemed to have one polarity, and during a charging event the opposite polarity.

The container 52 includes a mud well 60 having mud rests 62. The mud well 60 includes sufficient volumetric space to collect mud residue formed as a result of battery operation over period of time. The mud rests 62 provide spacing for the plates 54 from the bottom of the mud well 60 such that semi-conductive material shed from the plates to fall below the plates (into the mud well) thereby reducing opportunity for this material to short circuit the plates. As will be appreciated, the volumetric open space of the mud well 60 available for the collection of mud residue can in some embodiments be larger than the volumetric space occupied by the mud rests 62, but such a relationship need not be present in all embodiments. For example in some forms the volumetric space available for mud residue can be the same or smaller as the volumetric space occupied by the mud rests 62. The mud rests 62 extend up from a bottom of the well 60 to space the battery plate 54 from the mud residue to aid in preventing unwanted events, such as short circuits that may occur via semi-conductive mud residue. As will be described below, one or more of the mud rests 62 define a passage for the conveyance of electrolytic fluid.

The energy storage device 50 also can include a vent 64 for the expulsion of gas produced as a byproduct of a charging event. As will be appreciated, the plates that are of positive (+) polarity during a charging event can generate a gas as a byproduct of the charging event. During the final stage of a typical recharge, also known as ‘finish,’ acid stratification generated in earlier stages of recharge which reduces charging efficiency can be ameliorated via gassing. Gassing involves generating hydrogen and oxygen bubbles in the plates. These gas bubbles enter the bulk electrolyte and induce movement that mixes electrolyte and removes stratification.

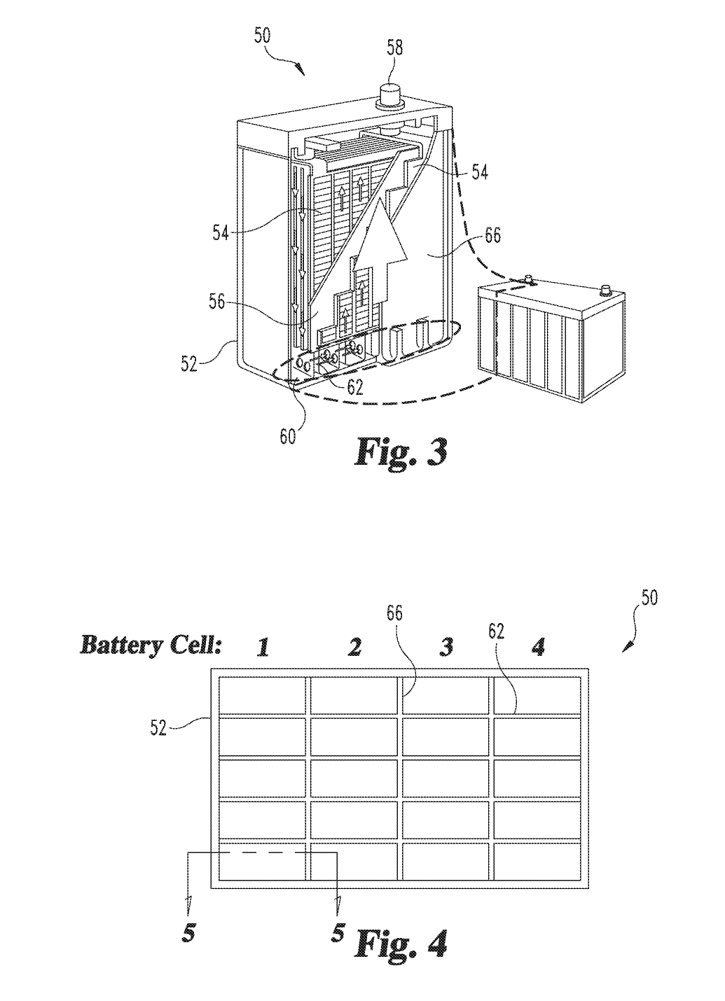

Turning now to FIGS. 2 and 3, another embodiment of the energy storage device 50 from FIG. 1 is shown. The detailed illustration shows a cutaway along the dotted lines of the full energy storage system 50. The cutaway is used for purposes of illustrating a particular cell of the battery formed through use of a partition 66. FIG. 3 depicts a flow of battery fluid via arrow illustrations and which is promoted through features to be discussed below.

FIGS. 4-7 illustrate an embodiment of the energy storage device 50 and the division of that device 50 into various cells. FIG. 4 depicts the device 50 having four separate cells, with a number of mud rests 62 spaced apart from one another and extending from left to right. Any number of cells can be used in other embodiments. Partitions 66 are also shown in FIG. 4. FIG. 5 depicts the cross sectional view of FIG. 4 in which various plates 54 and separators 56 are used.

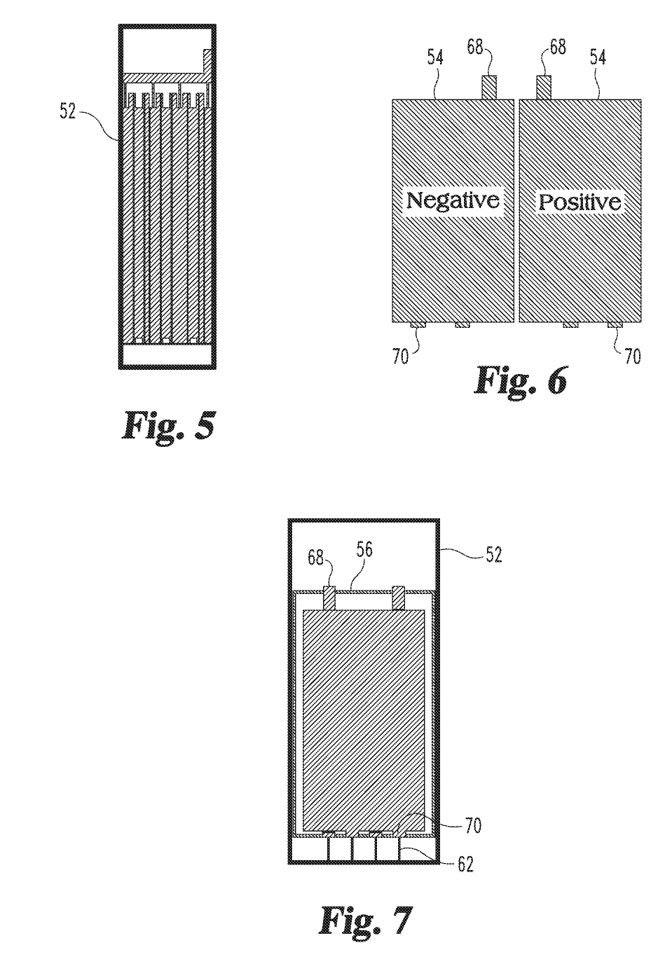

FIG. 6 illustrates embodiments of plates 54 in which a negative plate is shown on the left and a positive plate on the right. Each of the plates 54 includes a lug 68 to be placed in electrical communication with the respective terminals 58, as well as mud rest feet 70 useful to engage the mud rests 62. Not all embodiments of the plates 54 need include the mud rest feet 70. The mud rest feet 70 can be integral to the plate 54 such that it is made of the same material, but in some forms can be a separate device. The mud rest feet 70 can be used to elevate a bottom of the plate 54 from the mud rest 62 to provide a space through which battery fluid can flow. The mud rest feet 70 can be spaced different from negative to positive plates such that negative plates contact mud rests 62 different from the mud rests 62 that are contacted by the positive plates. The spacing of the feet 70 illustrated in FIG. 6 depict this arrangement. FIG. 7 illustrates a side view of the cross section in FIG. 5.

Although the plates 54 are shown as flat and roughly quadrilateral in shape in various figures above, the plate 54 can take on any variety of shape. As such, as used herein the term plate refers to any suitable device capable of participating in an electrolytic battery cycle event whether or not the structure is arranged as a flat device having substantially planar first side and second side. Curvilinear plates and other variety of shapes are also contemplated herein.

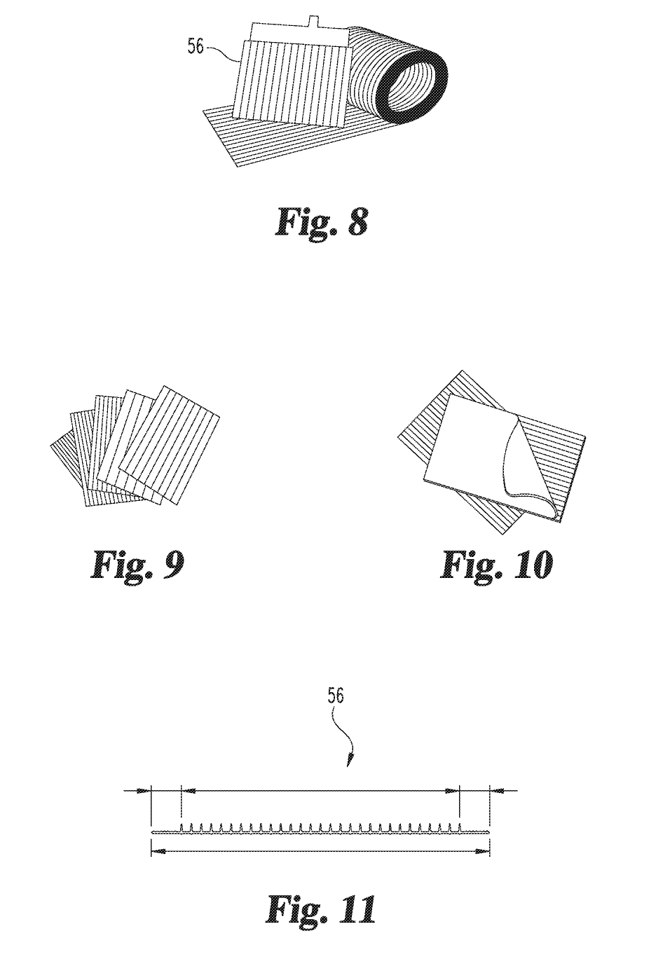

FIGS. 8-11 depict embodiments of various material, constructions, and arrangements of separators 56. To set forth just a few nonlimiting characteristics, the separator can include a porous material that provides electrical insulation while allowing ionic current through the separator. The separator can be made of rubber or polyethylene, among other potential materials.

FIG. 8 depicts an example polyethylene roll stock for producing separators 56, along with an example construction of a separator envelope. FIGS. 9 and 10 depict example rubber leaf separators. FIG. 11 depicts a cross section of a separator 56 which includes a number of ribs 72 extending from one face of the separator 56, while on the other side is relatively flat. One or more functions of the ribs 72 include: provide a reservoir of electrolyte adjacent to the positive plate, provide a gas channel through which gasses may escape, as well as reduce separator oxidation by limiting contact with the positive plate active material PbO2 (in the case of lead battery plates). In some forms the other side includes surface that is largely unresponsive to any protrusion formations of the ribs 72. A rib margin is provided at the ends of the separators 56.

The ribs 72 form open channels and that extend along a length of the separator 56. The channels can be the same across the entire separator surface, but in some embodiments one or more of the channels can be different. To set forth just a few nonlimiting examples, the cross sectional shape can change over the length of the channel. The channel is structurally arranged with a spacing that encourages flow of battery fluid in the presence of gaseous byproduct of charging.

The separators 56 can be arranged for positive plates or for negative plates such that the orientation of the channels relative to the particular plate 54 depends on the polarity of the plate (such as the polarity of the plate during a charging event). In some embodiments only positive plates have separators 56, other embodiments only the negative plates have separators 56, while in still other embodiments the energy storage device 50 can include one or more separators used with positive plates as well as one or more separators be used with negative plates.

The material used in the separator 56 can take on the form of a pocket for use in the device 50. The pocket can include an open top for ease of insertion of a battery plate where the top is located near the top of the container 52 including the terminals 58. As used herein the term “top” of the pocket, or for that matter the term “bottom”, are used herein for descriptive purposes and for ease of reference to distinguish between opposite ends of the pocket or other features of the device 50. The terms are not otherwise intended to be strictly limited in orientation in all embodiments.

One nonlimiting embodiment of a pocket having an open top can be seen in the separator 56 illustrated in FIG. 8. In some forms the pocket includes a closed bottom, but in other embodiments the pocket includes an open bottom similar to a sleeve. The term pocket thus refers to an enclosure within which a battery plate 54 is located while being sufficient to functionally separate that battery plate from an adjacent opposite polarity battery plate. The enclosure can be entirely enclosed (like a Latin American food called an empanada, or an Italian food dubbed a calzone), while in others it includes an opening at just one end for insertion of a battery plate, while in still other forms includes one or more apertures at an end that are of sufficiently small size to allow passage of battery fluid but otherwise prevent insertion/removal of a battery plate, or in still further embodiments includes openings at both a first end and a second end that can be sufficient to pass a plate 54.

The separator 56 pocket can be formed from a single sheet of stock material folded either on a side or at the bottom to form the enclosure, but in other embodiments the pocket can be formed from one or more separate sheets that are joined together using any variety of techniques such as mechanical (e.g. stitching) or chemical joining (e.g. bonding), among other potential varieties.

One or both of the front and back sides of the pocket can be “coupled” together in the sense that multiple separate pieces of separator material can be joined together near an edge of the separator 56 to form the pocket, or the sides can be “coupled” in the sense that each side is a separate geometric feature of the pocket of an otherwise single piece of material, such that the sides are conventionally considered “coupled” together at a change in feature like from the first side to the second side.

If a separator pocket is used to enclose the plate considered the positive (+) battery plate during charging, the grooved/channeled surface of the separator pocket would be located on an inside of the pocket to facilitate removal of the gaseous byproduct. Such a pocket can have an open bottom or a closed bottom. If the separator pocket is used to enclose the plate considered the negative (−) battery plate during charging, the grooved/channeled surface of the separator pocket would be located on an outside of the pocket to face the adjacent positive (+) plate (as viewed during the charging event) to facilitate removal of the gaseous byproduct.

In those embodiments in which the separator 56 pocket includes a closed bottom and is used on the positive (+) plate when charged, openings can be formed in the bottom of the separator 56 pocket. Such openings can all be the same or different sizes, and can be formed at the apex of the fold, or in a location near the fold if the separator is formed from a sheet of material which folds around the bottom of the pocket. The openings can be formed via perforations, such as with a processing machine used to form the pocket that includes a cutter employed specifically to form the perforations.

The channels on the separators (as seen in one embodiment in FIG. 56) can oriented in a vertical direction to permit the relatively lower density electrolyte (formed via gaseous introduction into the electrolyte) to be pushed up as heavier electrolyte seeks to takes its place by virtue of hydrostatic forces.

Turning now to the mud rests 60, as depicted above in some form the container 52 can include one or more mud rests 62 upon which the plates 54 rest. The mud rests 62 can be formed integral with the base of the container 52, but in some forms the mud rests 62 are separately formed and later coupled with the container 52. Any number of mud rests 62 can be used having any size and shape. Depicted in the embodiment of FIGS. 2 and 3 are ribs of a rectangular cross sectional shape. The shape can be constant along the length of the rib or can vary. The mud rests 62 can be arranged at substantially right angles to the plates 54 (as seen in the embodiment of FIG. 4), but other orientations are also contemplated.

Turning now to another alternative and/or additional feature of the application, various passages 74 can be provided near the bottom of the container 52 to permit flow of battery fluid transverse to the mud rests 62 such that battery fluid can circulate. In some forms the passages 74 can extend across all mud rests 62 at roughly the same orientation and location on each plate, but other arrangements are also contemplated herein.

The passages can take on a variety of forms. In one embodiment nonlimiting embodiment shown in FIG. 3, the passages 74 are formed as internal passages to the mud rests such that a the mud rest forms all or part of the passage 74, while in other alternative and/or additional embodiments the passages 74 are formed between adjacent mud rests 62. In still other forms, the passages 74 can be formed in the top surface of the mud rest 62, such that one side of the passage 74 is defined by the mud rest 62 (e.g. an indentation in the top of the mud rest 62), and the other side defined by a bottom of the plate 54 or plate/separator combo.

In those embodiments in which the passage 74 is formed internal to the mud rest, the internal passages can include inlet/outlet apertures having any size and shape. Any number of apertures can be provided, and can be provided in any configuration. The apertures can change size and/or shape from one side of the mud rest to another. The passage extending between the apertures can have constant cross sectional shape and size, but can also vary in some embodiments from one end to the other.

In some forms the apertures constitute a single inlet and a single outlet in which a continuous through hole extends between the inlet to the outlet. In other embodiments, a through hole may be coupled with one or more inlets and/or one or more outlets. Thus, some embodiments of the mud rests 62 can include passages 74 having a single inlet and outlet, along with one or more passages 74 a plurality of inlets and/or outlets.

In the embodiments in which the passages 74 are partially formed in the top of the mud rest 62 (e.g. indentations), the inlet/outlet openings (functionally similar to the apertures in the internal passage embodiment above) in the mud rest 62 will be understood to be the contour formed in the mud rest 62 (e.g. from the indentation) that permits the beginnings of a flow path. An enclosed flow path will be formed when the plate or plate/separator combo are used in conjunction with the mud rest 62 such that the plate or plate separator form one side of the flow path and the contour formed in the mud rest 62 forms another side. The openings can extend any length away from the location of the plate or plate/separator combo. Such an indentation formed in the mud rest 62 can proceed in a line from one lateral side of the mud rest 62 to the other, but in additional and/or alternative embodiments the indentations can proceed in a curvilinear, piecewise linear, nonlinear, etc manner from one portion of the mud rest 62 to the other.

The shape, length, size, and manner of forming the apertures, openings, and passages can be the same or different for any of the other apertures, openings, and passages. Furthermore, the apertures, openings, and passages can be formed through any variety of techniques. In one nonlimiting embodiment the apertures, openings, and/or passages can be formed as perforations, such as those that are formed through a process in which an instrument is used to penetrate a material, or alternatively penetrate to weaken a material for subsequent completion of process. In other alternative and/or additional techniques, the apertures, openings, and/or passages can be molded and/or cast into the material that is used to form the mud well and/or mud rests.

As will be appreciated when referencing FIG. 1, a space 76 is located between the ends of the plates 54 and an inside wall of the container 52. Such a space permits battery fluid to reside, and to circulate during certain operating conditions of the battery. For example, in some forms battery fluid can descend from a top of the container 52 to the bottom, through the passages 74 defined by the mud rests 62, and up through the channel features of the separator 56 pocket during a charging event of the battery when gas is emitted into the battery fluid. Particular embodiments incorporated features above will now be discussed.

In one embodiment the energy storage system includes the following:

(1) perforated or discontinuous mud rests below the plates that allow free lateral flow of electrolyte;

(2) pocket separators applied to negative plates such that the gas channel adjacent to the positive plate is open to the battery fluid reservoir in the mud well OR in the case of positive plate pocket separators, the bottom is perforated at the fold to similarly allow access to the acid in the mud well either case facilitates the upward flow of electrolyte; and

(3) a charge algorithm that includes reduced overcharge since copious charge is no longer required to mix electrolyte.

In another non-limiting embodiment the energy storage system includes:

(1) a pocket separator is applied to the positive plates by cutting to length, wrapping bottom to top, and mechanically sealing the sides as in typical methods. However, as the separator material is cut to length, an additional cutting operation is performed that perforates the separator at the midpoint where the separator will be folded around the bottom of the plate. This may be accomplished by adding an additional blade to the roll cutter. The perforations allow the material the hinge or fold around the plate as before. The perforations further provide openings between the gas channels and the electrolyte in the mud well below;

(2) The mud rests that support the plates from below are perforated or molding in a discontinuous form such the lateral flow of electrolyte is not impeded; and

(3) The free flow of electrolyte enabled by 1 and 2 above allow acid stratification to be quickly removed when gassing begins in the later stage of recharge, Therefore prolonged recharge for the purpose of mixing is not required. The charge termination criteria then can limit charge length to that which is required to charge the plates. This minimizes overcharge and avoids accelerated positive grid corrosion.

In still another embodiment the energy storage device includes:

(1) a pocket separator is applied to the negative plates by cutting to length, wrapping bottom to top, and mechanically sealing the sides as in typical methods. Since the separator is wrapped around the negative plate with the ribs facing the positive plate, gas channels are open to the battery uid in the mud well below;

(2) the mud rests that support the plates from below are perforated or molding in a discontinuous form such the lateral flow of electrolyte is not impeded; and

(3) the free flow of electrolyte enabled by 1 and 2 above allow acid stratification to be quickly removed when gassing begins in the later stage of recharge. Therefore prolonged recharge for the purpose of mixing is not required. The charge termination criteria then can limit charge length to that which is required to charge the plates. This minimizes overcharge and avoids accelerated positive grid corrosion.

In still a further embodiment the energy storage device includes:

(1) a pocket separator is applied to the positive plates by cutting to length, wrapping around the side, and mechanically sealing the remaining side as in typical methods. Since the separator is wrapped around the plate without sealing the bottom, the gas channels are open to the electrolyte in the mud well below;

(2) the mud rests that support the plates from below are perforated or molding in a discontinuous form such the lateral flow of electrolyte is not impeded; and

(3) the free flow of electrolyte enabled by 1 and 2 above allow acid stratification to be quickly removed when gassing begins in the later stage of recharge. Therefore prolonged recharge for the purpose of mixing is not required. The charge termination criteria then can limit charge length to that which is required to charge the plates. This minimizes overcharge and avoids accelerated positive grid corrosion.

The embodiment immediately above which uses a pocket separator having an open bottom, sometimes referred to as a sleeve separator are typically used in batteries of capacity associated for use in forklifts and renewable energy storage.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
an energy storage device having a base and sides forming a container and structured to contain a battery fluid and a battery plate;
a mud rest extending away from a mud well bottom and having at least a first upright portion and second upright portion, the first upright portion and second upright portion extending to a top of the mud rest which is structured to support the battery plate of the energy storage device; and
a fluid passage extending between an opening formed in one upright portion of the mud rest to an opening formed in another upright portion of the mud rest, the fluid passage configured for the passage of battery fluid between the one upright portion of the mud rest and the another upright portion of the mud rest.

2. The apparatus of claim 1, wherein the mud rest includes a plurality of fluid passages extending from one lateral side of the mud rest to an opposite lateral side of the mud rest.

3. The apparatus of claim 2, wherein the mud well includes a plurality of mud rests that extending away from the mud well bottom, and which further includes a passage space between adjacent mud wells that permit the flow of batteryluid in a direction transverse to at least one of the adjacent mud wells.

4. The apparatus of claim 1, which further includes the battery plate and the battery fluid, and wherein the battery plate is included in a plurality of opposing polarity battery plates that are each disposed within the container and are at least partially submerged in the battery fluid, the opposing polarity plates being a set of first polarity plates and a set of second polarity plates interleafed such that one of the set of first polarity plates is adjacent to one of the second polarity plates, the set of first polarity plates at a first polarity during charging of the energy storage device and a second polarity during discharge of the energy storage device, the set of second polarity plates at the second polarity during charging of the energy storage device and the first polarity during discharge of the energy storage device.

5. The apparatus of claim 4, which further includes a separator interposed between the one of the first polarity plates and the one of the second polarity plates, the separator including a first side having a first face and a second side having a second face, the first face including a channel feature to convey a buoyant flow of battery fluid.

6. The apparatus of claim 5, wherein the mud rest is structured to support the one of the first polarity of plates, wherein the separator is formed as a pocket and further includes a plurality of channel features on the first face, and which further includes a fluid flow path for the passage of battery fluid, the fluid flow path including the fluid passage for the passage of battery fluid between the one upright portion of the mud rest and the another upright portion of the mud rest, the fluid flow path continuing to the channel feature on the first face.

7. The apparatus of claim 6, wherein the pocket includes a closed bottom, and wherein the energy storage device further includes a vent for the external passage of gas generated internal to the energy storage device.

8. The apparatus of claim 7, wherein the first face of the pocket is arranged according to one of: (1) on a side that faces the battery plate when the battery plate is configured as a positive plate during a charging event of the energy storage device; and (2) on a side that faces away from the battery plate when the battery plate is configured as a negative plate during a charging event of the energy storage device.

9. The apparatus of claim 6, wherein the pocket includes an open bottom.

10. An apparatus comprising:
a flooded battery separator having a material composition structured for use with an electrolyte fluid and a shape and size configuration that inhibits the formation of a short circuit between adjacent battery plates between which the flooded battery separator is interposed, the separator formed as a pocket between a first side part and a second side part and having an open end through which one of the adjacent battery plates can be inserted, the first side part and the second side part of the flooded battery separator each including a first face and a second face opposite the first face, the first side and the second side coupled together along their respective ends to form the pocket, the first face of each of the first side part and second side part having a grooved surface defining a plurality of channels with upright extending walls and open tops that extend toward the open end, the plurality of channels structured with sufficient size to convey a mixture of electrolyte fluid and gaseous byproduct of a charging event of a flooded battery, the second face of each of the first side part and second side part lacking a surface feature complementary to the grooved surface on the first face of the separator.

11. The apparatus of claim 10, wherein the first face and the second face are coupled along a side that extends between the opposite lateral sides to form a pocket having the open end.

12. The apparatus of claim 11, wherein the first face of each of the first side part and second side part form opposing external sides of the pocket such that the plurality of channels are formed on an outside surface of the pocket.

13. The apparatus of claim 12, wherein the side is a bottom of the pocket, and wherein the coupling along the bottom is such that the first face and the second face are part of a single sheet of material that is wrapped around the bottom.

14. The apparatus of claim 10, wherein the first face of each of the first side part and second side part form internal surfaces of the pocket such that the plurality of channels are formed on internal facing surfaces of the pocket.

15. The apparatus of claim 14, wherein the first face and the second face are part of a single sheet of material that is wrapped around a bottom of the flooded battery separator.

16. The apparatus of claim 15, wherein openings are formed in proximity to the bottom where the single sheet of material is wrapped around the bottom of the pocket.

17. The apparatus of claim 14, wherein the pocket is in the form of a sleeve having open ends at a top and bottom of the sleeve.

18. The apparatus of claim 17, wherein the pocket is formed of a single piece of material.

19. An apparatus comprising:
an electric storage device having container within which is disposed a plurality of first polarity plates interleafed with a plurality of second polarity plates;
a plurality of separators disposed between the plurality of first polarity plates and plurality of second polarity plates, at least one separator of the plurality of separators disposed between an adjacent first polarity plate and second polarity plate;
a plurality of vertically extending channels formed in at least one of the plurality of separators, the plurality of vertically extending channels forming passages for the conveyance of electrolyte fluid;
a mud well having a mud rest upon which at least one of the first polarity of plates can be supported, the mud rest defining an internal passage arranged to convey the electrolyte fluid as the fluid circulates during an operation of the electric storage device;
wherein a fluid circulation path is defined during a charging operation of the electric storage device, the circulation path extending via the passage and continuing from the passage up and along the vertically extending channels of at least one of the plurality of separators, the circulation path returning to the mud well after extending up and along the vertically extending channels.

20. The apparatus of claim 19, the circulation path extending from the top of the plurality of first polarity plates in proximity to at the end of the vertically extending channels to a space between an outer reach of the plates and an inside wall of the container, the circulation path thereafter extending within the space toward the bottom of the container.

21. The apparatus of claim 20, wherein the container is a closed container that includes a vent for the expulsion of gas generated during an operation of the electric storage device.

22. The apparatus of claim 21, wherein the passage is internal to the mud rest, and which further includes a plurality of passages.

23. The apparatus of claim 21, which further includes an additional passage for the conveyance of electrolyte fluid, the additional passage located between the mud rest and an adjacent mud rest.

24. The apparatus of claim 21, wherein the at least one separator is formed as a pocket having a channeled surface.

25. The apparatus of claim 24, wherein the channeled surface is located on an outside of the pocket, wherein the inside of the pocket lacks a channeled surface, and wherein the passage is internal to the mud rest.

26. The apparatus of claim 24, wherein the channeled surface is located on an inside of the pocket, and wherein the outside of the pocket lacks a channeled surface.

27. The apparatus of claim 26, wherein the pocket includes one of a closed bottom and an open bottom, and wherein the electric storage device further includes a first terminal and a second terminal both accessible from an external position to the device, the plurality of the first polarity of the plates electrically connected to the first terminal, the plurality of the second polarity of the plates electrically connected to the second terminal.
